(19) United States
(12) Patent Application Publication
(10) Pub. No.: US 2015/0354924 A1
(43) Pub. Date: Dec. 10, 2015

(54) Aluminum Backed Steel Armor

(71) Applicant: Jamin Micarelli, Woodinville, WA (US)

(72) Inventor: Jamin Micarelli, Woodinville, WA (US)

(21) Appl. No.: 14/694,999

(22) Filed: Apr. 23, 2015

Related U.S. Application Data
(60) Provisional application No. 61/983,654, filed on Apr. 24, 2014.

(51) Int. Cl. F41H 5/04; B32B 37/12

(52) U.S. Cl. CPC F41H 5/045; B32B 37/1207; B32B 2250/03; B32B 2311/00

(57) ABSTRACT

A composite armor having at least one sheet of HHS and at least one sheet of aluminum. The sheet of HHS is adhered to the sheet of aluminum with a sheet of adhesive material.

### CROSS REFERENCE TO RELATED APPLICATIONS

This application claims priority to US Provisional Patent application 61/983654 filed Apr. 24, 2014, which is hereby incorporated by this reference as if fully set forth herein:

### TECHNICAL FIELD

This disclosure relates to armor and more particularly to armor composed of multiple layers.

### BACKGROUND

Both steel and aluminum find usage as armor plating, particularly for vehicles. A type of steel known as High Hard Steel (HHS), when properly prepared according to conventional specifications, is especially favored for steel armor applications. HHS is, in a manner of speaking, virtually impenetrable by conventional projectiles, such as those fired from conventional high-powered military weapons.

But HHS is notoriously brittle, especially at 60 R (Rockwell) and above. In fact, depending on weight and velocity of the impacting round, a plate of such steel will actually shatter, rendering it catastrophically useless for its intended purpose.

### DISCLOSURE

An aluminum backed steel armor is disclosed. It is believed that such a combination of materials for armor does not exist. In particular, a plate of HHS is backed by a plate of conventional aluminum, with the two plates joined by a conventional adhesive, advantageously a sheet adhesive.

The aluminum plate is believed to absorb and or dissipate some portion of the stress introduced into the steel plate by the impact of the projectile, so that the steel plate does not shatter, but retains its integrity to stop and or deflect the striking projectile, and to continue to serve its armor purpose over a series of such strikes.

This is especially valuable when using the harder steels, such as HHS. HHS with Rockwell hardness in the range of 60 and above is particularly effective in stopping conventional projectiles from high-power weapons, providing it does not shatter. With the disclosed aluminum backing, HHS R60+ becomes a highly effective armor plate.

### BRIEF DESCRIPTION OF THE DRAWINGS

FIG. 1 is a schematic cross section of the disclosed armor.

### DETAILED DESCRIPTION

Turning now to the drawings, the disclosed armor will be described by reference to the numerals of the drawing figures wherein like numbers indicate like parts.

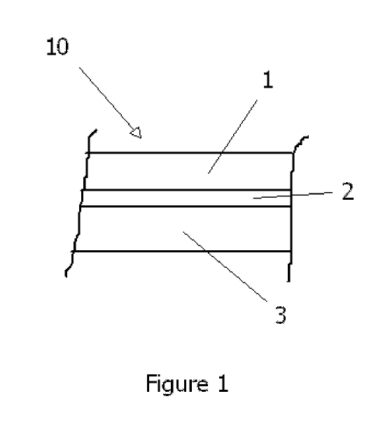

In FIG. 1 multiple layer armor 10 includes a sheet of HHS 1, one or more sheets of adhesive 2 and a sheet of aluminum 3.

Advantageously, the two sheet materials (steel and aluminum) are joined and placed in a heated press at about 200 degrees F. and at 200 psi, with the sheet adhesive between the material plates to effect optimal adhesion. A Boroclave press is desirable. Any conventional sheet adhesive can be made to serve, with polyurethane and polyolefin adhesives serving particularly well.

Plate thicknesses can be varied to suit the armor application and mission. However HHS plate material from 2 to 4 mm up to about 12-13 mm when joined to aluminum plate from about 0.020 inches (0.5 mm) up to about 1 inch (25 mm) are effective combinations.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A composite armor comprising at least one sheet of HHS and at least one sheet of aluminum, at least one sheet of HHS adhered to at least one sheet of aluminum with at least one sheet of adhesive material.

2. The armor of claim 1 wherein the adhesive sheet material is selected from the group of sheet materials consisting of polyurethane and polyolefin.

3. The armor of claim 1 wherein the HHS has Rockwell hardness of 60 or more.

4. The armor of claim 1 wherein the HHS plate material is from 2 mm up to about 12-13 mm thick, and the aluminum plate is from about 0.5 mm up to about 25 mm thick.

5. A method of making armor, the method comprising the steps of:
A. preparing a sheet of HHS for adhesive bonding with a sheet of aluminum;
B. disposing a sheet of adhesive material between the two sheets to form a pre-press assembly;
C. subjecting the pre-press assembly to about 200 degrees F. at 200 psi.
